(19) United States
(12) Patent Application Publication
(10) Pub. No.: US 2025/0388499 A1
(43) Pub. Date: Dec. 25, 2025

(54) SYSTEMS AND METHODS FOR SEQUESTERING CARBON DIOXIDE AND NEUTRALIZING ACIDIFICATION OF WATER BODIES USING ALKALINE FLUIDS

(71) Applicant: Knudsen Holdings LLC, Cape Elizabeth, ME (US)

(72) Inventors: Justin Baker RIES, Swampscott, MA (US); Matthew Jordan ODLIN, Freeport, ME (US); Mikko Pekka KOSKINEN, Reykjavík (IS)

(21) Appl. No.: 19/039,206

(22) Filed: Jan. 28, 2025

Related U.S. Application Data
(63) Continuation of application No. PCT/US2023/071339, filed on Jul. 31, 2023.
(60) Provisional application No. 63/393,381, filed on Jul. 29, 2022.

(51) Int. Cl. C02F 1/66; B01D 53/14; B01D 53/62; B01D 53/78

(52) U.S. Cl. CPC C02F 1/66; B01D 53/1475; B01D 53/1493; B01D 53/62; B01D 53/78; B01D 2252/103; B01D 2257/504; B01D 2258/06

(57) ABSTRACT

A method for carbon dioxide sequestration includes extracting an alkaline fluid from a natural source, such as surface waters, shallow subsurface/subterranean waters, deep subsurface waters, hydrothermal brines, oil-field brines, sub-seafloor brines, evaporite brines, and/or the like. At least one of the alkaline fluid and/or an aggregate substrate formed at least in part by the alkaline fluid is conveyed to a target deployment location in a body of water by, for example, a shipping vessel, a flexible barge, a well, a pipeline, a canal/aqueduct, a natural channel and/or slope, a freezing and rafting process, a buoy/substrate, and/or the like. The method includes enhancing an alkalinity of at least a portion of the body of water based at least in part on the alkaline fluid, thereby promoting the sequestration of atmospheric carbon dioxide in the body of water.

### CROSS-REFERENCE TO RELATED APPLICATIONS

This application is a continuation of International Patent Application No. PCT/US2023/071339 filed Jul. 31, 2023, entitled “Systems and Methods for Sequestering Carbon Dioxide and Neutralizing Acidification of Water Bodies Using Alkaline Fluids,” which claims priority to and the benefit of U.S. Provisional Patent Application No. 63/393,381, filed Jul. 29, 2022, entitled “Systems and Method for Sequestering Carbon Dioxide Using Alkaline Fluids,” the disclosures of each of which is incorporated herein by reference in its entirety.

### BACKGROUND

Embodiments described herein relate to sequestering atmospheric carbon dioxide and neutralizing acidification of water bodies and more particularly, to methods of using alkaline fluids for carbon dioxide sequestration and/or to enhance systems for carbon dioxide sequestration, and methods of distributing the same.

Human activity has increased atmospheric carbon dioxide (CO₂) by approximately 50% (from ˜280 to 420 ppm) over the past 200-300 years due to population growth, combustion of fossil fuels, land use changes, and other industrial processes. These anthropogenic increases in atmospheric CO₂ have led to a variety of environmental and societal problems, including global warming, increased wildfires, increased droughts, increased severity and frequency of storms, sea level rise, melting glaciers, and ocean acidification. One of the great challenges facing humanity in the 21^{st} century is to develop scalable systems and/or methods for removing CO₂ from the atmosphere in order to stabilize and reduce atmospheric CO₂ and neutralize acidification of natural water bodies, thereby limiting the environmental and humanitarian damage that is associated with increasing atmospheric CO₂. Thus, there is a need for systems, methods, and/or materials for facilitating carbon capture and/or sequestration and neutralizing acidification of water bodies.

### SUMMARY

In some implementations, a method for carbon dioxide sequestration includes extracting an alkaline fluid from a natural source, such as surface waters, shallow subsurface/subterranean waters, deep subsurface waters, hydrothermal brines, oil-field brines, sub-seafloor brines, evaporite brines, and/or the like. At least one of the alkaline fluid and/or an aggregate substrate formed at least in part by the alkaline fluid is conveyed to a target deployment location in a body of water by, for example, a shipping vessel, a flexible barge, a well, a pipeline, a canal/aqueduct, a natural channel and/or slope, a freezing and rafting process, a buoy/substrate, and/or the like. The method includes enhancing an alkalinity of at least a portion of the body of water based at least in part on the alkaline fluid, thereby promoting the sequestration of atmospheric carbon dioxide and/or neutralization of acidification in the body of water.

### BRIEF DESCRIPTION OF THE DRAWINGS

FIG. 1 is a schematic illustration of a process of using alkaline fluids for CO₂ capture and/or sequestration, according to an embodiment.

FIG. 2 is as flowchart of a method of enhancing alkalinity, according to an embodiment.

### DETAILED DESCRIPTION

Embodiments described herein relate to sequestering atmospheric carbon dioxide and more particularly, to methods of using alkaline fluids for carbon dioxide sequestration and/or to enhance systems for carbon dioxide sequestration, and methods of distributing the same. Alkaline fluids suitable for use in CO2 sequestration can be derived from natural or industrial reaction of water with alkaline minerals. Alkaline minerals such as, for example, metal silicates, carbonates, and/or evaporites are globally abundant—forming about 45% of the Earth's continental crust (covering about 30% of Earth's surface) and nearly 100% of subsurface (i.e., below the upper sedimentary layer) oceanic crust (covering about 70% of Earth's surface).

Some examples of idealized metal-silicate carbonation reactions that yield alkaline fluid (e.g., waters) suitable for CO₂ sequestration and/or neutralization of acidification of water bodies are:

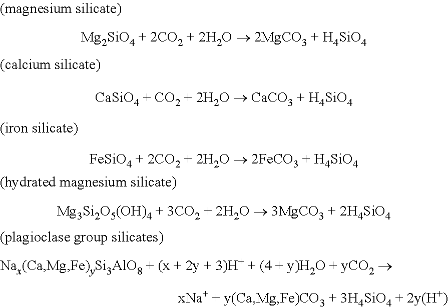

Some examples of carbonate mineral dissolution reactions that yield alkaline fluid (e.g., waters) suitable for CO₂ sequestration are:

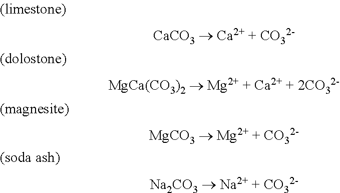

The liberated CO₃²⁻ ions from these carbonate dissolution reactions take up free H⁺ (protons) via the reaction:

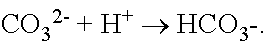

Some examples of metal oxide mineral dissolution reactions that yield alkaline fluid (e.g., waters) suitable for CO₂ sequestration are:

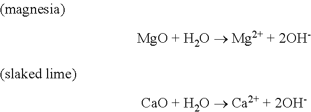

Some examples of metal hydroxide mineral dissolution reaction that yields alkaline fluid (e.g., waters) suitable for CO₂ sequestration are:

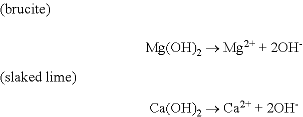

The liberated OH⁻ ions from this reaction will take up free H⁺ (protons) via the reaction:

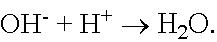

Thus, these dissolution reactions decrease free H⁺ (acting to increase pH and reverse acidification) and increase alkalinity of the surface waters (e.g., ocean alkalinization or alkalinity enhancement), thereby shifting the carbonate equilibria below to the right, resulting in a net transfer of atmospheric CO₂ to aqueous CO₂ via Henry's Law to re-establish the carbonate equilibria:

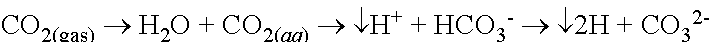

The aqueous HCO₃⁻ and CO₃²⁻ ions can be stable in natural aqueous systems such as lakes, ponds, rivers, seas, or oceans, and can remain stable for hundreds to thousands of years.

One known method for using alkaline minerals for CO₂ sequestration includes mining from natural deposits and then grinding and pulverizing the mineral into very small sizes (e.g., a gain size of about 100 microns to 300 microns) in order to increase their reactive surface area. The ground/pulverized minerals are then reacted with fluids that experience an increase in alkalinity (e.g., CO₃²⁻, HCO3-, OH—) and divalent cation concentration (e.g., Ca2+, Mg2+, Fe2+), which increases the capacity of the fluid (e.g., water) to absorb CO₂ and mineralize it as a solid carbonate mineral (e.g., CaCO3, MgCO3, FeCO3). Relatedly, in some instances, ground and/or pulverized alkaline minerals are added to and/or distributed in natural surface waters, shorelines, and/or rivers, which then react and/or dissolve and increase alkalinity of these waters. The resulting reactions shifts the carbonate equilibrium of the waters in favor of sequestering CO₂ from the atmosphere to the alkalinized waters.

This processing of the alkaline minerals, however, requires extensive grinding and pulverizing of minerals down to the 100 micron to 300 micron grain size in order to increase their reactive surface area and increase their rate of CO₂ sequestration to a level that is capable of contributing to the stabilization or reduction of atmospheric CO₂. Moreover, the hardness and density of some alkaline minerals (e.g., metal silicates) make grinding/pulverizing expensive, both from an energetic standpoint and from a CO₂ emissions standpoint, which reduces the value of the sequestered CO₂ on both the top line (i.e., after reducing revenue by cost of energy) and bottom line (after reducing revenue by cost of emitted CO₂), reducing the economic viability of this method for sequestering CO₂.

Rates and magnitudes of CO₂ sequestration via reaction with alkaline minerals can also be increased by heating the reactants, but this too is expensive from both energetic and CO₂ emission standpoints, reducing the economic viability of this method for sequestering CO₂. The cost of sequestering CO₂ via industrial weathering of ground, pulverized, and/or heated alkaline minerals may exceed the value of a CO₂ credit that is generated from that reaction, rendering the process economically unviable as a method for sequestering atmospheric CO₂. In addition, it can be difficult to quantify the CO₂ sequestered through the release of alkaline minerals to natural water and/or bedrock systems because of the open nature of these systems and the relatively slow reaction times. Furthermore, the products of the reaction between the alkaline minerals, CO₂, and water (e.g., clays, solid carbonate minerals, metal silicates, etc.) are chemical byproducts/waste products, the disposal of which may incur additional costs (e.g., economic, energic, environmental, and/or the like).

Another conventional method for using alkaline minerals for CO₂ sequestration that avoids the high costs of grinding, pulverizing, and/or heating the alkaline minerals includes injecting pure CO₂ streams (e.g., from fossil fuel-fired power plants or other industrial sources) into alkaline bedrock, where the injected CO₂ reacts with divalent cations (Ca, Mg, Fe) and alkalinity (CO₃²⁻, HCO₃⁻, OH⁻) dissolved in the groundwater within the bedrock to be durably sequestered in the form of a solid carbonate minerals (e.g., CaCO₃, MgCO₃, FeCO₃). In these applications, the slow reaction kinetics between the alkaline fluids and the non-pulverized metal silicates are overcome by the many years that the existing groundwater has been reacting with the metal silicate bedrock and generating the alkalinity and divalent cations required to sequester the introduced CO2, which in some cases occurs under elevated temperatures that accelerate the kinetics of these reactions. Through this pathway, the CO₂ is injected (directly or indirectly) into the metal silicate bedrock and associated alkaline and high-total dissolved solids (TDS) groundwater and converted to a solid carbonate mineral (e.g., CaCO3, MgCO3, FeCO3).

In some instances, however, the conversion of gaseous or liquified CO₂ to a solid carbonate mineral after it is injected into alkaline bedrock can increase the volume of the local bedrock by up to 30%, which can expand and uplift the bedrock. This can cause hills to form rapidly above the injection sites, which can modify the natural landscape and built environment, lead to an increase in the frequency of local earthquakes, and pollute the local groundwater, thus creating environmental, geological, and public health hazards that are often associated with hydraulic fracturing (‘fracking’). Moreover, sites for injecting CO₂ into alkaline bedrock are limited and transport of pure CO₂ streams to injection sites can require expensive and unsightly infrastructure and/or delivery methods. The capacity for an injection site to store pure CO₂ streams is also limited. Once the capacity of an injection site for storing CO₂ is exceeded, anew injection site is located and drilled, and the infrastructure for delivering the pure CO₂ stream is relocated and rebuilt. In general, there is a 1-10-year lag between when the CO₂ is injected into the alkaline bedrock and when that CO₂ is stably sequestered as a solid carbonate mineral, during which time the injected CO₂ can rise back to the surface layer of the alkaline bedrock and re-enter the atmosphere. In some instances, the alkaline bedrocks can be relatively soluble (e.g., limestones) such that large sections of the bedrock dissolve after injection of CO₂ into their associated waters, resulting in potential collapse (e.g., sink holes).

Although chemical weathering of alkaline minerals is one of the primary pathways by which CO₂ is sequestered from the Earth's fast carbon cycle in the atmosphere and upper ocean to the slower carbon cycle in the deep ocean, marine sediments, and marine limestones over geological timescales, the relatively slow rate of these chemical reactions poses challenges for the industrial adaptation of these reactions that would enable the process to sequester CO₂ at a scale that could stabilize and/or reduce atmospheric CO₂ and the associated negative environmental and socio-economic impacts. The potential high cost of extracting the alkaline fluids and minerals and/or pulverizing the alkaline minerals, as well as potential high costs of transporting the alkaline material to target locations, typically renders conventional methods of CO₂ sequestration via alkalinity enhancement and/or enhanced weathering economically unviable. For at least the reasons stated above, such known methods of chemical weathering of alkaline minerals to sequester CO₂ are not suitable for large-scale, atmospherically significant carbon sequestration.

In contrast, the embodiments and/or methods described herein relate to low-energy methods for CO₂ sequestration using, for example, globally abundant, naturally occurring alkaline fluids. In some implementations, naturally occurring alkaline fluids can be used to capture and/or sequester CO₂ from the Earth's fast carbon cycle (e.g., the upper ocean and atmosphere) to its slow carbon cycle (deep ocean, marine sediments, rocks and other upper subterranean reservoirs). In general, alkaline fluids are naturally high in pH (e.g., alkaline or basic), alkalinity, and divalent cation concentration. Thus, alkaline fluids are suited for large scale CO₂ sequestration, for example, via alkalinity enhancement (e.g., ocean, estuarine, or freshwater) and/or mineralization. In some instances, natural alkaline fluids can also have high temperatures at the point of extraction, which can be advantageous if used in the production of substrates that are aggregated, for example, with cementitious and/or polysaccharide hydrogel binders. For example, the natural high temperatures can reduce the heat input that may otherwise be used to activate and/or cure these binders. In some instances, the high concentration of divalent cations and high alkalinity can also speed the activation and/or curing process of cementitious and/or hydrogel binders. As described in further detail herein, such substrates, in turn, can be used in systems and/or methods for CO₂ sequestration.

For example, in some implementations, a method for carbon dioxide sequestration includes extracting an alkaline fluid from a natural source, such as surface waters, shallow subsurface/subterranean waters, deep subsurface waters, hydrothermal brines, oil-field brines, sub-seafloor brines, evaporite brines, and/or the like. The alkaline fluid is conveyed to a target deployment location in a body of water by, for example, a shipping vessel, a flexible barge, a well, a pipeline, a canal/aqueduct, a natural channel and/or slope, a freezing and rafting process, a buoy/substrate, and/or the like. The method includes enhancing the alkalinity of at least a portion of the body of water based at least in part on the alkaline fluid, The method includes enhancing an alkalinity of at least a portion of the body of water based at least in part on the alkaline fluid, thereby promoting the sequestration of atmospheric carbon dioxide in the body of water.

In some implementations, alkaline fluids can be used in the production of substrates, aggregates, and/or other materials, which in turn, are used to capture and/or sequester CO₂. For example, in some implementations, a method for carbon dioxide sequestration includes extracting an alkaline fluid from a natural source and forming an aggregate substrate. At least a portion of the aggregate substrate is activated via the alkaline fluid, the activating resulting in at least one of a binding or a curing of at least the portion of the aggregate substrate. The aggregate substrate is deployed at a target deployment location in a body of water. The method includes enhancing an alkalinity of at least a portion of the body of water based at least in part on the aggregate substrate being deployed therein.

In some embodiments, any suitable system can be used to extract and/convey the alkaline fluid in any desired manner. For example, in some embodiments, a system for alkalinity enhancement can include an extractor configured to extract an alkaline fluid from a natural source. The system further includes a conveyor configured to convey at least one of the alkaline fluid or aggregate substrate formed at least in part by the alkaline fluid to a target deployment location in a body of water, where the at least one of the alkaline fluid or the aggregate substrate conveyed to the target deployment location is operable to enhance an alkalinity of at least a portion of the body of water.

Any of the embodiments and/or methods described herein also can provide for and/or can include determining a target location based on one or more characteristics associated with the portion of the body of water. In addition, any of the embodiments and/or methods described herein can provide for and/or can include estimating the amount of atmospheric CO₂ that is sequestered via reaction with the distributed alkaline fluids, which in some instances, may be valued and sold, for example, as a carbon offset credit.

In some embodiments, the alkaline fluids can be used to neutralize acids or acidic materials released through additional or other processes associated with CO₂ removal, such as the sinking of biomass (e.g., macroalgae and/or any other biomass) in water bodies that can, in some cases, release small quantities of organic acids into the water bodies. In some embodiments, the alkaline fluids can be used to capture and/or durably retain in solution CO₂ that is released through additional or other processes associated with CO₂ removal, such as the sinking of biomass in water bodies that can release small quantities of CO₂ into water bodies and/or the atmosphere through, for example, microbial remineralization of particulate organic carbon and/or dissolved organic carbon. Examples of devices, systems, and/or methods for CO₂ removal using water-based (e.g., ocean-based) techniques such as sinking biomass can include, but are not limited to, those described in U.S. Pat. No. 11,382,315 (“the '315 patent”), filed Jun. 8, 2021, entitled “Systems and Methods for the Cultivation of Target Product;” U.S. Patent Publication No. 2023/0106744 (“the '744 publication”), filed Sep. 30, 2022, entitled “Systems and Method for Quantifying and/or Verifying Ocean-Based Interventions for Sequestering Carbon Dioxide;” U.S. Patent Publication No. 2023/0152292 (“the '292 publication”), filed Jan. 19, 2023, entitled “Systems and Methods for Monitoring Ocean-Based Carbon Dioxide Removal Devices and Accumulation of a Target Product;” International Patent Application No. PCT/US2023/064917 (“the '917 PCT”), filed Mar. 24, 2023, and entitled “Floating Substrates for Offshore Cultivation of Target Products and Methods of Making and Using the Same;” International Patent Application No. PCT/US2023/064919 (“the '919 PCT”), filed Mar. 24, 2023, and entitled “Floating Substrates Including Carbonaceous Coatings for Offshore Cultivation of Target Products and Methods of Making and Using the Same;” and/or U.S. Provisional Patent Application No. 63/401,959 (“the '959 provisional”), filed Aug. 29, 2022, entitled “Ocean Based Carbon Removal Systems and Methods of Using The Same,” the disclosure of each of which is incorporated herein by reference in its entirety.

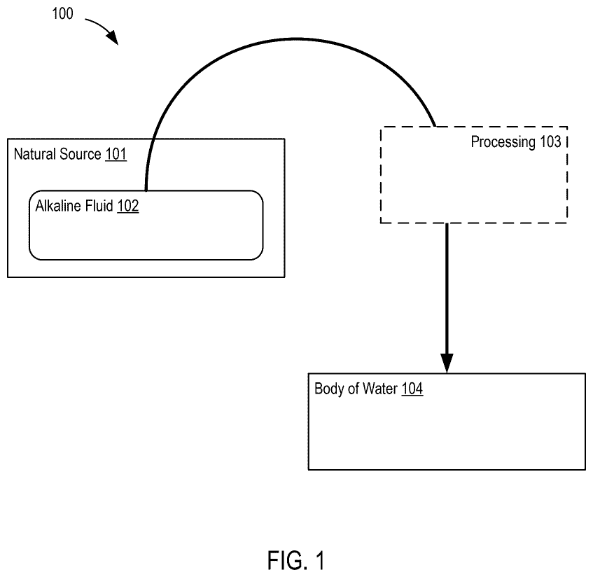

FIG. 1 is a schematic illustration of a process 100 of using alkaline fluids for CO₂ capture and/or sequestration, according to an embodiment. In general, the process 100 includes extracting alkaline fluid 102 from a natural source 101 and distributing the alkaline fluid 102 into a body of water 104 such as an ocean, where the alkaline fluid can enhance and/or increase the alkalinity of the surrounding waters, which in turn, can increase a capacity for capturing and/or sequestering CO₂, as described in detail above.

The naturally occurring alkaline fluids 102 can be found within the natural source 101 such as alkaline mineral deposits including, for example, metal silicates (e.g., mafic and/or ultramafic igneous rocks), limestones, dolostones, evaporite deposits, and/or the like. More specifically, the natural source 101 can be alkaline minerals deposits that host alkaline groundwaters and/or brines including metal silicates (e.g., mafic/ultramafic igneous rocks), carbonates (e.g., limestones, dolostones, magnesite) and evaporite deposits (e.g., brucite).

In addition, the natural source 101 of the alkaline fluids 102 can be, for example, surface waters, shallow subsurface/subterranean waters, deep subsurface waters, hydrothermal brines, oil-field brines, sub-seafloor brines, evaporite brines, and/or the like. More specifically, surface waters can include, for example, any alkaline waters found on the surface of land or the oceans, including alkaline lakes, rivers, cold springs, hot springs, alkaline freshwater lenses floating on the surface of the ocean due to their relative low density, and/or the like; shallow subsurface waters can include, for example, groundwaters found in the upper portion of the continental crust; deep subsurface waters can include, for example, basinal brines, which are brines trapped in ancient basins (geosynclines) that are now landlocked, and potentially deeply buried under sediments and rocks; hydrothermal brines can include, for example, brines formed through a reaction of water, seawater, or brine with hot alkaline rocks and/or magma; oil-field brines can include, for example, brines co-occurring with oil and/or gas deposits that are in some cases extracted and isolated through drilling for and/or extraction of oil and/or gas from the subsurface; sub-seafloor brines can include, for example, brines derived from the reaction of seawater that has infiltrated the oceanic crust and reacted with alkaline basalt in the upper layers of the oceanic crust and/or highly alkaline ultramafic deposits in the deeper layers of the oceanic crust; and evaporite brines can include, for example, brines produced from the partial evaporation and resulting ionic concentration of meteoric water, seawater, or other natural waters in landlocked or marginal marine basins. In some implementations, the alkaline fluids 102 (e.g., waters) can be extracted from these various natural sources 101 through conventional well-drilling, recirculation, and/or other surface collection methods.

While described as being naturally occurring and/or being extracted from the natural source 101, the alkaline fluids 102 also can be produced through the industrial reaction (weathering) of pulverized alkaline minerals with fluids (e.g., waters), as described above. The process of mining, transporting, pulverizing, and reacting the alkaline minerals, however, is expensive in terms of time, money, and CO₂ emissions. In contrast, utilizing natural alkaline fluids in CO₂ sequestration can be more efficient because the fluid-rock reactions that generate the unique chemistry of the alkaline fluids that make them useful in sequestering CO₂ have already occurred in natural, geological systems over many years and, in some cases, at elevated pressures and temperatures that would be difficult to efficiently replicate in an industrial setting. Moreover, the extraction and/or transportation of naturally occurring alkaline fluids can be performed using relatively efficient, existing techniques. In some instances, however, industrially created alkaline fluids and/or alkaline fluids that are the waste or byproduct of other industrial processes, for example, may be used in the process of CO₂ sequestration in manners similar to those described herein with reference to naturally occurring alkaline fluids.

Embodiments described herein can use any suitable system, device, and/or method for extracting alkaline fluids from any suitable source (e.g., natural sources as described above). Such systems and/or devices performing extraction methods are generally referred to herein as “extractor(s).” For example, a non-exhaustive list of suitable extractors can include, but is not limited to, wells, pumps, pipelines, siphons, hydraulic injection systems, and the like.

As described above, the alkaline fluid 102 can be extracted from the natural source 101 (or industrial source if industrially produced) via conventional processes. Once extracted, it may be desirable to distribute the alkaline fluids 102 into environments where CO₂ capture and/or sequestration can be performed efficiently. For example, as shown in FIG. 1, the alkaline fluids 102 can be distributed into and/or along target locations of a body of water 104 such as an ocean, sea, lake, estuary, rivers, etc. In some instances, target locations can be determined based at least in part on an efficiency and/or effectiveness of CO₂ sequestration (e.g., by the body of water 104 or portion thereof having enhanced alkalinity resulting from the presence of the alkaline fluid 102, by the alkaline fluid 102 itself, and/or by any additional/other suitable carbon removal intervention).

In some implementations, target locations may include locations where water temperatures are sufficiently low to inhibit precipitation of dissolved alkalinity as solid (e.g., mineral) alkalinity. For example, precipitation may release some of the CO₂ that was originally removed through the addition of alkaline fluids to the natural water body. Targeting colder waters for CO₂ removal by alkalinity enhancement may also increase the rate and magnitude of CO₂ removal in response to the enhanced alkalinity, as the solubility of CO₂ in seawater increases with decreasing water temperatures. In some implementations, target locations may include upwelling regions/zones of a water body (or conversely the avoidance of downwelling zones), as alkalinity released into upwelling regions/zones can remain in the surface waters longer than if they were released into non-upwelling zones or into downwelling zones, thereby increasing the amount of time that CO₂ can enter, be captured by, and/or reacted with the alkalinized surface water, which in turn, can increase the amount of CO₂ transferred from the atmosphere to the water body with the enhanced alkalinity.

In some implementations, for example, determining a target location can be based on collected and/or historical data associated with the body of water 104, environmental conditions, deployment methods, and/or any other suitable data. In some implementations, determining a target location and/or determining a desired efficiency and/or effectiveness for CO₂ sequestration can include the use of systems and/or methods in which one or more machine learning models and/or the like are executed to analyze collected data, provide a predictive output, and/or the like. For example, such systems and/or methods can be similar to or substantially the same as any of the systems and/or methods (or portions thereof) described in the '744 publication incorporated by reference hereinabove.

In some implementations, the amount of CO₂ removed through alkalinity enhancement can be quantified and/or verified through the measurement and/or prediction of a change in dissolved inorganic carbon (DIC) in the water body before and after alkalinity enhancement and/or by a change in total alkalinity of the water body before and after deployment. In some implementations, such measurements and/or predictions can include the use of one or more efficiency factor(s) that describes and/or that is otherwise associated with the increase in dissolved inorganic carbon per unit increase in total alkalinity (e.g., not to exceed an efficiency factor of 1). In cases where the total volume of the alkalinized portion of the water body are known, total CO₂ removed through alkalinity enhancement can be calculated by multiplying the change in the measured concentration of DIC (for a given sample of water) by the total volume (or predicted, estimated, and/or calculated total volume) of the alkalinized portion of the water body.

In cases where the volume of the alkalinized portion of the water body is not known (e.g., open systems), but the amount of total alkalinity added to the water body is known, quantifying CO₂ removal and any additional, other, and/or ancillary processes can include the use of conservative chemical tracers, including a concentration and/or ratio of any known element(s) (e.g., Ca²⁺, Mg²⁺, Sr²⁺, Li⁺, Zn²⁺, etc.) and/or corresponding isotope(s) (e.g., Ca⁴⁵, Mg²⁴, Sr⁸⁶, Li⁷, Zn⁶⁷, etc.) within (or added to) the alkaline material, including any concentrations and/or ratios of elements and/or isotopes (or combinations thereof), that exhibit(s) known stoichiometric and/or empirical relationships to alkalinity within the alkaline material and/or, once dissolved, to other relevant components of the aqueous carbonate system (e.g., total alkalinity in solution, dissolved inorganic carbon).

In some implementations, such a tracer-based approach to quantifying chemical processes associated with CO₂ removal by alkalinity enhancement of aqueous systems can in turn be used to quantify various parameters of interest, including, but not limited to, for example, the concentration of alkalinity available for CO₂ removal; the concentration of alkalinity consumed by ancillary acids released through additional and/or other water (e.g., ocean) based interventions for removing CO₂ (e.g., organic acids leaching from floating biomass used to deliver alkalinity); the concentration of gross alkalinity released to the water body (e.g., alkalinity available for CO₂ removal and alkalinity consumed by acids released through ancillary, additional, and/or other water based interventions); the proportions of the alkalinity available for CO₂ removal vs. acid neutralization relative to gross alkalinity released; the efficiency of the alkaline material at removing CO₂; the rate of CO₂ removal by alkalinity enhancement; changes in the any suitable parameter(s) (e.g., any of the above-described parameter(s)) through normalization to total alkalinity released through alkalinity enhancement and/or total water volume affected by the alkalinity enhancement; dilution factors of alkalinized water bodies; rates of dilution of alkalinized water bodies; and/or the like. In some implementations, the tracer-based approach described herein can allow quantification of relevant and/or associated processes involved in CO₂ removal by alkalinity enhancement without, for example, knowing a total volume of water involved in the process (e.g., so long as a total quantity of alkaline material deployed is known).

For example, a tracer-based approach, process, and/or method for quantifying parameters of interest associated with CO₂ removal through alkalinity enhancement may include obtaining samples of alkaline materials and affected waters (before and after deployment). The alkaline materials can be analyzed for potential tracer ions (e.g., concentrations of elements, such as [Ca²⁺], [Mg²⁺], [Sr²⁺], [Li⁺], [Zn²⁺], etc., and/or isotopes thereof) and total alkalinity. In some implementations, one or more tracer ion(s) can be added to the alkaline material. Water samples can then be analyzed for total alkalinity, pH, temperature, conductivity, potential tracer ions, and/or the like. The DIC of the water samples can be either measured directly or calculated from measured TA, pH, conductivity, temperature, and/or the like. The measured change in alkalinity of the water (e.g., ocean water, seawater, saltwater, etc.), for example, represents the cumulative net change in total alkalinity (“Δ[TA_{N}]”), or the excess alkalinity released per units of seawater available for CO₂ removal after neutralization of organic acids, as provided below:

$$Δ [ {TA}_{N} ] = ( {TA}_{f} - {TA}_{i} ) ,$$

where TA_{f} is the measured TA after deployment and TAᵢ is measured TA before deployment.

Because alkalinity is derived from dissolution of some known mineral with a fixed stoichiometric and/or empirical molar ratio of alkalinity to some tracer ion (M) in (or added to) the alkaline mineral (like major, minor, and/or trace elements such as, for example, Mg, Sr, Zn, Li, etc. (and/or isotopes thereof)) that exists in some fixed stoichiometric and/or empirical relationship with alkalinity, a cumulative measure of change in gross total alkalinity (TA_{G}) per unit of seawater can be derived from a change in molar concentration of the tracer ion(s) multiplied by the stoichiometric and/or empirical alkalinity/tracer ion molar ratio (R) in the alkaline mineral (e.g., for a Ca(OH)₂ alkalinity source and a Ca²⁺ tracer ion, the alkalinity (OH—)/tracer ion (Ca²⁺) molar ratio R would be 2/1), as provided below:

$$Δ [ {TA}_{G} ] = R \times ( {[ M ]}_{f} - {[ M ]}_{i} ) ,$$

where [M]_{f} is the measured tracer ion(s) [M] after deployment, [M]ᵢ is the measured tracer ion(s) before deployment, and R is the stoichiometric molar ratio of alkalinity/tracer ion in the alkaline source mineral.

As described above, ion tracers can include, for example, any concentrations or ratios of any known element (e.g., Ca2+, Mg2+, Sr2+, Li+, Zn2+, etc.) and/or corresponding isotope(s) (e.g., Ca45, Mg24, Sr86, Li7, Zn67, etc.), including any combination(s) of concentrations and/or ratios of elements and/or isotopes. The difference between the gross change in total alkalinity (ΔTA_{G}) and the net change in total alkalinity (Δ[TA_{N}]) represents the cumulative loss of alkalinity per unit of seawater due to neutralization of organic acids (Δ[TA_{A}]), as provided below:

$$Δ [ {TA}_{A} ] := Δ [ {TA}_{G} ] - Δ [ {TA}_{N} ]$$

Therefore, the proportion of gross total alkalinity addition allocable to acid neutralization (pTA_{A}) is:

$${pTA}_{A} = Δ [ {TA}_{A} ] / Δ [ {TA}_{G} ]$$

Likewise, the proportion of gross total alkalinity addition allocable to alkalinity enhancement (e.g., ocean alkalinity enhancement (OAE)) (pTA_{N}) is:

$${pTA}_{N} = Δ [ {TA}_{N} ] / Δ [ {TA}_{G} ]$$

A cumulative measure of the change in dissolved inorganic carbon (ΔDIC) per unit of seawater can be derived from the change in molar concentration of DIC in seawater, as provided below:

$$Δ [ DIC ] = {DIC}_{f} - {DIC}_{i}$$

where DIC_{f} is the measured DIC after deployment and DICᵢ is measured DIC before deployment.

A cumulative measure of carbon dioxide removal (CDR) efficiency by OAE (CDRₑ) can therefore be calculated as the change in DIC divided by the change in net TA, as provided below:

$${CDR}_{e} = Δ [ DIC ] / Δ [ {TA}_{N} ]$$

Likewise, the rate of CO₂ removal per unit change in net alkalinity (CDRᵣ) can be calculated, as provided below:

$${CDR}_{r} = Δ [ DIC ] / Δ [ {TA}_{N} ] / t$$

where t is an amount of time after deployment of alkaline materials that the water sample was collected.

Based at least in part on the relationships described above, and assuming that total gross alkalinity released to the seawater is equivalent to total moles of readily soluble alkalinity in alkaline mineral or brine added to seawater during deployment (ALK), the following absolute values (in moles), as of the time of the water samples were collected, can be estimated, calculated, and/or predicted, as provided below:

Sum of total alkalinity consumed by acid neutralization=ALK×pTA_{A}=ALK×(Δ[TA_{A}]/Δ[TA_{G}])

Sum of total alkalinity available for CO₂ removal=ALK×pTA_{N}=ALK×(Δ[TA_{N}]/Δ[TA_{G}])

Cumulative CO₂ removal by alkalinity enhancement=CDRₑ×ALK×pTA_{N}=(Δ[DIC]/Δ[TA_{N}])×ALK×(Δ[TA_{N}]/Δ[TA_{G}])

Rate of CO₂ removal by alkalinity enhancement=CDRₑ×ALK×pTA_{N}/t=(Δ[DIC]/Δ[TA_{N}])×ALK×((Δ[TA_{N}]/Δ[TA_{G}])/t)

Assuming that water samples are obtained in a timeseries at approximately the same location within the plume, this method also allows for estimation of dilution factors (‘DF’) and dilution rates (‘DR’) from the absolute decrease in measured concentration of tracer ion [M] (e.g., Ca²⁺ for Ca(OH)₂ source of alkalinity) with time after a maximum tracer [M] is identified, which can be used, for example, to constrain and/or inform (at least in part) models of plume dispersion, dilution, and mixing. For example, the dilution factors can be calculated, as provided below:

$$DF = {Δ [ M ]}_{max} / {Δ [ M ]}_{min} - 1$$

where Δ[M]ₘₐₓ is a maximum difference in measured tracer ion [M] before and after deployment and Δ[M]ₘᵢₙ is a minimum difference in measured tracer ion [M] before and after deployment, and DF is the dilution factor associated with an amount of unreacted seawater mixed into the reaction plume between the time that Δ[M]ₘₐₓ and Δ[M]ₘᵢₙ were sampled.

The dilution rate (DR) can be expressed as a fraction of plume volume at time of sampling Δ[M]max, as provided below:

$$DR = DF / t = ( {Δ [ M ]}_{max} / {Δ [ M ]}_{min} - 1 ) / t$$

where t is the time between sampling of Δ[M]ₘₐₓ and Δ[M]ₘᵢₙ, and DR is the dilution rate associated with a rate of mixing of unreacted seawater into the reaction plume as a fractional rate of plume volume at time of sampling Δ[M]ₘₐₓ.

Distribution of the alkaline fluid 102 into the body of water 104 can be performed via any suitable system, device, method or combination(s) thereof. As used herein, the terms “distribute” and “convey” generally relate to one or more processes or methods for storing, transporting, delivering, and/or deploying the alkaline fluid 102 into the body of water at the desired target location. Such systems and/or devices performing distribution methods are generally referred to herein as “conveyor(s)” and/or “distributor(s).” For example, a non-exhaustive list of suitable conveyors/distributors can include, but is not limited to, a shipping vessel, a flexible barge, a well, a pipeline, a canal/aqueduct, a natural channel and/or slope, a buoy, a substrate, systems for performing one or more freezing and/or rafting processes, and/or the like. Provided below is a discussion of non-limiting aspects and/or features of certain distribution methods. While certain aspects and/or features are described, it should be understood that the concepts and/or distribution methods described are provided by way of example only. Other distribution methods and/or combinations thereof are contemplated.

### Distribution of Alkaline Fluids by Shipping Vessel

In some implementations, the alkaline fluids 102 can be transported/distributed to a target deployment location/environment in or on the body of water 104 in the hulls, holds, and/or storage compartments of shipping vessels, such as those used for the transport of oil and/or other liquids. The alkaline fluids 102 also can be used as ballast water for vessels transporting other goods. In some implementations, the alkaline fluids 102 can be released gradually or all at once into target surfaces of the body of water 104 for CO₂ sequestration via alkalinity enhancement when, for example, the ballast water was no longer needed.

### Distribution of Alkaline Fluids by Flexible Barge

In some implementations, the alkaline fluids 102 can be transported/distributed to a target deployment location/environment in or on the body of water 104 in flexible barges, which are towable, non-rigid, and/or expandable barges constructed from fabric, plastic, and/or other flexible and inflatable material(s) such as, for example, flexible barges used to efficiently transport oil, chemicals, and drinking water by ocean or other bodies of water.

### Distribution of Alkaline Fluids by Well

In some implementations, the alkaline fluids 102 can be transported/distributed to a target deployment location/environment in or on the body of water 104 (e.g., surface waters or the like) via the wells or the like used to extract the alkaline fluids 102 from subsurface deposits. For example, the wells can be installed within ultramafic and/or mafic oceanic crust, which contains a high fraction of alkaline generating minerals such as olivine. In some implementations, the wells can be extended to surface platforms (similar to oil wells) in order to efficiently deliver the alkaline fluids 102 to proximal surface waters 104, thereby sequestering CO₂ through the alkalinization of these surface waters 104.

### Distribution of Alkaline Fluids by Pipeline

In some implementations, the alkaline fluids 102 can be transported/distributed to a target deployment location/environment in or on the body of water 104 (e.g., surface waters or the like) via pipelines placed either on land and/or seafloor. In such implementations, the pipelines can be used in a manner similar to oil and/or gas pipelines, water distribution systems, and/or sewer systems.

### Distribution of Alkaline Fluids by Canal/Aqueduct

In some implementations, the alkaline fluids 102 can be transported/distributed to a target deployment location/environment in or on the body of water 104 (e.g., surface waters or the like) via one or more canal, canal system, and/or aqueduct. In such implementations, the canal, canal system, and/or aqueduct can be used in a manner similar to how irrigation and/or drinking water is distributed through some known canal and/or aqueduct systems.

Distribution of Alkaline Fluids by Natural Channels and/or Slopes

In some implementations, the alkaline fluids 102 can be transported/distributed to a target deployment location/environment in or on the body of water 104 (e.g., surface waters or the like) via naturally occurring channels and/or slopes, such as rivers, creeks, streams, canyons, arroyos, dry channels, cave systems, hillslopes, and/or other sloping geomorphological systems. In such implementations, the natural channels and/or slopes can be used to transport the alkaline fluids 102, for example, to larger bodies of water for the purposes of sequestering CO₂ in a manner similar to how these natural systems transport meteoric waters (e.g., rain, snowmelt, etc.) and discharged groundwaters to larger bodies of water.

### Distribution of Alkaline Fluids by Freezing and Rafting

In some implementations, the alkaline fluids 102 can be transported/distributed to a target deployment location/environment in or on the body of water 104 (e.g., surface waters or the like) by freezing and releasing/deploying in solid form. For example, in general, the frozen alkaline fluids 102 are less dense than seawater, causing them to float on the surface waters 104 and gradually release alkalinity to the surface waters 104 as the frozen alkaline fluids melt. In some implementations, the alkaline fluids 102 can be frozen in combination with terrestrial biomass, forming a ‘pykrete buoy’ and/or the like configured to gradually release alkalinity and terrestrial biomass as the frozen alkaline fluid melts. Similarly, alkalinity enhancing minerals, such as crushed limestone, magnesium hydroxide, calcium hydroxide, olivine, and/or other metal silicates could be frozen along with the alkaline fluids 102, which in some instances, can modify the melting rate of the alkaline fluids 102 and deliver additional alkalinity to the surface waters 104 through chemical weathering and/or dissolution thereof.

### Distribution of Alkaline Fluids by Buoy/Substrate

In some implementations, the alkaline fluids 102 can be transported/distributed to a target deployment location/environment in or on the body of water 104 (e.g., surface waters or the like) within and/or via buoys. For example, such buoys can be configured to contain, transport, and/or slowly release the alkaline fluids 102. In such implementations, the buoys can be configured to contain sufficient air to maintain a positive buoyancy, at least for a desired time. In some embodiments, the

As shown in FIG. 1, in some implementations, the process 100 may optionally include processing 103 the alkaline fluids in any suitable manner(s) prior to distributing at the target location. For example, in some implementations, the optional processing 103 can include using the alkaline fluids 102 in the construction of a buoy and/or any other suitable substrate. In such implementations, the buoy/substrate can be configured to gradually degrade and/or dissolve in the body of water 104, thereby releasing alkalinity associated with and/or resulting from the alkaline fluids 102, even if the fluids have been precipitated or substantially precipitated out as alkaline minerals through the process of constructing the buoy/substrate. For example, in some implementations, a buoy can be bound and/or constructed from a partially cementitious material (e.g., similar to many marine buoys) and the alkaline fluids 102 can be used in the activation of the cementitious reactions that bind the buoy together. The alkalinity stored in the cementitious binder would then be released as the buoy dissolves, thereby transporting/distributing the alkalinity from the natural source 101 to the target location/environment of the body of water 104. Non-limiting/non-exhaustive examples of suitable buoys and/or substrates are described, for example, in the '919 PCT incorporated by reference hereinabove.

In other implementations, the optional processing 103 can include using the alkaline fluids 102 in the hydration of a polysaccharide binder used in the construction of the buoy/substrate, such as psyllium or rice husk, which results in a hydrogel and/or mineralized hydrogel. For example, the formation of the hydrogel can stabilize and/or immobilize the alkaline fluid 102 until the hydrogel binder dissolves or breaks down at the target location, thereby releasing alkalinity into the body of water 104. Non-limiting/non-exhaustive examples of suitable buoys and/or substrates are described, for example, in the '917 PCT incorporated by reference hereinabove.

In some instances, the alkaline fluids 102 can be stored and/or contained in the natural source 101 at relatively high temperatures, which can be advantageous if used in the production of substrates that are aggregated, for example, with cementitious and/or polysaccharide hydrogels by reducing the heat input required to activate and/or cure these binders. In some instances, the relatively high concentration of divalent cations and alkalinity can also speed the activation and/or curing process of cementitious and/or hydrogel binders, among other mechanical and/or chemical binders, used in the production of buoys and/or substrates engineered for CO₂ sequestration.

In some implementations, the buoys and/or substrates can be configured to provide a structure for cultivating a target product such as, for example, macroalgae and/or the like. For example, the buoys and/or substrates can be similar to and/or substantially the same any of those described in the '315 patent, the '744 publication, the '292 publication, the '917 PCT, the '919 PCT, and/or the '959 provisional incorporated by reference hereinabove. In such implementations, the buoys and/or substrates can be configured to float and/or otherwise provide positive buoyancy for at least a predetermined period while the target product grows and accumulates biomass. During the predetermined period (or at one or more discrete times during the predetermined period), the buoys and/or substrates can be configured to at least partially dissolve, degrade, break down, and/or otherwise lose buoyancy, which in turn, can reduce a net buoyancy of the buoy/substrate and target product. In some implementations, after the target product has grown and accumulated a desired amount of biomass, the buoy/substrate and the target product can sink to the bottom of the water body. As such, by accumulating biomass, the target product can capture CO₂ via photosynthesis, and by sinking the buoy/substrate and target product, the captured CO₂ can be durably sequestered and/or stored.

As described above, the alkaline fluid used to form the buoy/substrate, the alkaline fluid stored and released by the buoy/substrate, and/or an amount of alkaline fluid released or deployed in conjunction with a deployment of the buoys/substrates can, for example, at least partially neutralize acids or acidic materials released through ancillary processes associated with CO₂ capture via the growth and/or accumulation of biomass of the target product seeded on, supported by, and/or at least temporarily floated by the buoys/substrates (e.g., a release of small quantities of organic acids into the water bodies as the target product grows). In some implementations, the alkaline fluids can be used to capture and/or durably retain in solution CO₂ that is released through ancillary processes associated with CO₂ removal, such as the sinking of biomass in water bodies that can release small quantities of CO₂ into water bodies and/or the atmosphere through, for example, microbial remineralization of particulate organic carbon and/or dissolved organic carbon. In some implementations, the alkaline fluid can replenish and/or supplement an amount of natural alkalinity my be otherwise removed or consumed by the target product as the target product grows and accumulates biomass.

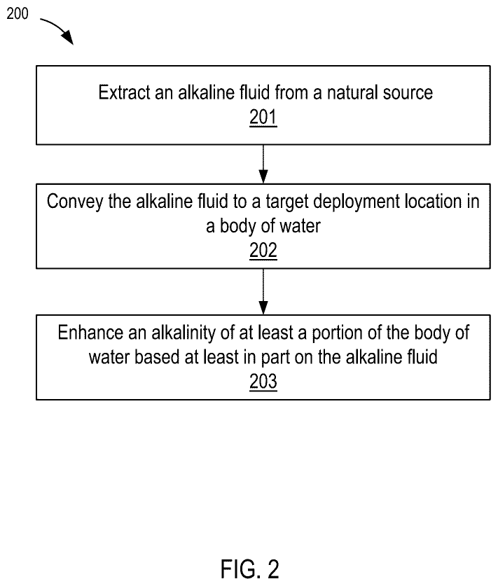

FIG. 2 is as flowchart of a method 200 of enhancing alkalinity, according to an embodiment. The method 200 can be implemented with and/or using any extractor and/or conveyor described herein. Alternatively, the method 200 can be implemented by any other system which may not necessarily use a conveyor and/or extractor.

The method 200 includes extracting an alkaline fluid from a natural source at 201. In some instances, the natural source is an alkaline deposit that hosts at least one of alkaline groundwater, alkaline brine, carbonate, or evaporite deposit(s). The extraction can be performed using any suitable method and/or extractor such as any of those described herein. For example, the natural source can be alkaline water, which can be extracted and/or collected using at least a surface collection method.

In some implementations, the method 200 includes forming an aggregate substrate and activating at least a portion of the aggregate substrate via the alkaline fluid. For example, activating the aggregate substrate can result in at least one of a binding or a curing of at least the portion of the aggregate substrate. In some implementations, the aggregate substrate is a buoy including a partially cementitious material. Activating such an aggregate substrate can include binding the partially cementitious material with a binder formed at least in part by the alkaline fluid.

The method 200 includes conveying the alkaline fluid to a target deployment location in a body of water at 202. In some implementations, the method 200 optionally includes determining the target deployment location based on at least one of an efficiency or effectives of CO₂ sequestration of at least the portion of the body of water in response to enhancing alkalinity. In some implementations, the method 200 optionally includes determining the target deployment location based on at least one of the body of water, historical data associated with the body of water, environmental conditions, or deployment methods.

The conveying can be performed using any suitable method and/or conveyor/distributor such as any of those described herein. For example, in some implementations, the alkaline fluid is conveyed in liquid or frozen form. In some implementations, frozen alkaline fluid that is delivered to the target deployment location may be allowed to melt within the body of water over a predetermined time. In some implementations, alkaline fluid may be frozen with at least one terrestrial biomass, alkalinity enhancing minerals, or materials configured to modify a melting rate of the frozen alkaline material.

In some implementations, the alkaline fluid may be conveyed and/or deployed to the target location via at least one of a shipping vessel, a flexible barge, a well, a pipeline, an aqueduct, a natural channel, a buoy, a substrate, and/or the like. In some implementations, the alkaline fluid is used to form, bind, and/or cure an aggregate substrate, which in turn is then conveyed to and/or deployed at the target deployment location in the body of water. After deploying the aggregate substrate, at least a portion of the aggregate substrate can be allowed to dissolve in the body of water over a predetermined time.

The method 200 includes enhancing an alkalinity of at least a portion of the body of water based at least in part on the alkaline fluid, an aggregate substrate formed by the alkaline fluid, and/or a dissolution or degradation (at least in part) of such a substrate at 203. In some embodiments, the method 200 optionally includes calculating an amount of CO₂ sequestered as a result of the enhanced alkalinity.

Any of the embodiments and/or methods described herein can overcome known challenges and/or high costs (in terms of both energy and emitted CO₂) associated with the grinding, pulverizing, and/or heating of alkaline minerals configured to increase reaction rates for industrially scalable CO₂ sequestration (e.g., such processes have naturally occurred over geological timescales in the natural subsurface systems at temperatures and/or pressures that typically support these reactions). In addition, the embodiments and/or methods described herein can avoid known challenges and/or environmental, geological, and hazards otherwise associated with subsurface injection of CO₂ into alkaline bedrock systems.

In some instances, any of the embodiments and/or methods described herein can use globally ubiquitous and/or abundant natural deposits of alkaline minerals and/or fluids to sequester CO₂ or otherwise to facilitate the sequestration of CO₂ from the fast to the slow carbon cycles at rates and scales capable of materially offsetting at least a portion of anthropogenic CO₂ released into the fast carbon cycles through the extraction and combustion of fossil fuels (among other processes).

In some instances, any of the embodiments and/or methods described herein can use natural alkaline fluids that reduce and/or minimize costs (e.g., in terms of money, time, and/or CO₂ emission) associated with large-scale CO₂ sequestration by utilizing, for example, the products of reactions that have already occurred over geological timescales in subsurface systems at temperatures and pressures that typically favor these reactions.

In some instances, any of the embodiments and/or methods described herein can use natural alkaline fluids that are naturally high in pH, alkalinity, and divalent cation concentration, and therefore suited for large-scale CO₂ sequestration via alkalinity enhancement and/or mineralization.

In some instances, any of the embodiments and/or methods described herein can use natural alkaline fluids that can be naturally hot at the point of extraction, thereby reducing the heat input otherwise used to activate and cure binders, such as cementitious and/or polysaccharide hydrogel binders, of aggregate substrates used in CO₂ sequestration.

In some instances, any of the embodiments and/or methods described herein can use natural alkaline fluids with a high concentration of divalent cations and alkalinity, which in turn, can speed the activation and/or curing process of cementitious and/or hydrogel binders used in the production of aggregate substrates used in CO₂ sequestration.

In some instances, any of the embodiments and/or methods described herein can use natural alkaline fluids that increase total amounts of CO₂ that can be sequestered into and/or by a body of water by elevating and/or enhancing its alkalinity, thereby shifting the carbonate chemical equilibria of the aqueous system in favor of transporting CO₂ from the atmosphere to the body of water.

In some instances, any of the embodiments and/or methods described herein can use natural alkaline fluids, the extraction, processing, and/or distribution of which results in less CO₂ being emitted by known processes used to increase the capacity of alkaline fluids to sequester atmospheric CO₂.

In some instances, any of the embodiments and/or methods described herein can use natural alkaline fluids that increase the efficiency of transporting alkalinity to target sites for CO₂ sequestration by, for example, maintaining the alkalinity in a fluid state, which in some instances, can allow for transport/distribution by efficient methods such as of buoys, shipping vessels, flexible barges, wells, pipelines, canals/aqueducts, natural channels and/or slopes, and/or the like.

In some instances, any of the embodiments and/or methods described herein can use natural alkaline fluids that can reduce and/or substantially minimize potential byproducts otherwise resulting from introducing alkaline minerals directly into marine and freshwater systems by adding alkalinity into these systems via natural alkaline fluids extracted from the alkaline mineral systems that are free of the particulate byproducts associated with these reactions.

In some instances, any of the embodiments and/or methods described herein can allow for the stabilization of alkaline fluids within the mechanical binders of buoyant substrates, such as cementitious carbonate minerals and/or polysaccharide hydrogels (e.g., psyllium husk, rice husk). In some instances, this can allow for extended transport over land or sea, followed by controlled release of the alkalinity as the binders disaggregate, dissolve, and/or melt once the target locations are reached.

In some instances, any of the embodiments and/or methods described herein can be configured to allow for greater control over the rate, timing, and/or location of introducing alkalinity into natural systems for the purposes of CO₂ sequestration by allowing the alkalinity to be introduced via fluids that can be systematically and immediately (or substantially immediately) titrated into the system, rather than through solid alkaline minerals that are suspended in and reacted with the natural bodies of water for longer intervals of time in order to result in the target alkalinity.

While various schematics, embodiments, and/or implementations have been described above, it should be understood that they have been presented by way of example only, and not limitation. Various modifications, changes, and/or variations in form and/or detail may be made without departing from the scope of the disclosure and/or without altering the function and/or advantages thereof unless expressly stated otherwise. Likewise, while embodiments and/or features, components, configurations, aspects, etc. thereof may be described above in the context of certain implementations, it should be understood that such implementations are presented by way of example only and not limitation. Any of the embodiments and/or features, components, configurations, aspects, etc. thereof can be used in, and/or adapted for use in, other implementations unless expressly stated otherwise. Functionally equivalent embodiments, implementations, and/or methods, in addition to those described herein, will be apparent to those skilled in the art from the foregoing descriptions and are intended to fall within the scope of the disclosure.

Where schematics, embodiments, and/or implementations described above indicate certain components arranged in certain orientations, configurations, or positions, the arrangement of components may be modified. Although various embodiments have been described as having particular features, configurations, and/or combinations of components, other embodiments are possible having a combination of any features, configurations, and/or components from any of embodiments described herein, except mutually exclusive combinations. The embodiments described herein can include various combinations and/or sub-combinations of the functions, components, configurations, and/or features of the different embodiments described.

The specific configurations of the various components can also be varied. For example, the size and specific shape of the various components can be different from the embodiments shown, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Where methods described above indicate certain events occurring in certain order, the ordering of certain events may be modified. Additionally, certain of the events may be performed concurrently in a parallel process, when possible, as well as performed sequentially as described above. While methods have been described as having particular steps and/or combinations of steps, other methods are possible having a combination of any steps from any of methods described herein, except mutually exclusive combinations and/or unless the context clearly states otherwise.

What is claimed:

1. A method, comprising:
extracting an alkaline fluid from a natural source;
conveying the alkaline fluid to a target deployment location in a body of water; and
enhancing an alkalinity of at least a portion of the body of water based at least in part on the alkaline fluid.

2. The method of claim 1, wherein the conveying includes conveying the alkaline fluid to the target deployment location via at least one of a shipping vessel, a flexible barge, a well, a pipeline, an aqueduct, a natural channel, a frozen raft, or a buoy.

3. The method of claim 1, further comprising:
freezing the alkaline fluid;
releasing the frozen alkaline fluid into the body of water at the target deployment location; and
allowing the alkaline fluid to melt within the body of water over a predetermined time.

4. The method of claim 3, wherein freezing the alkaline fluid includes freezing the alkaline fluid with at least one of terrestrial biomass, alkalinity enhancing minerals, or materials configured to modify a melting rate of the frozen alkaline material.

5. The method of claim 1, further comprising:
forming an aggregate substrate;
activating at least a portion of the aggregate substrate via the alkaline fluid, the activating resulting in at least one of a binding or a curing of at least the portion of the aggregate substrate.

6. The method of claim 5, wherein the conveying includes conveying the aggregate substrate to the target deployment location, the method further comprising:
deploying the aggregate substrate into the body of water; and
allowing at least a portion of the aggregate substrate to dissolve in the body of water over a predetermined time.

7. The method of claim 1, wherein the natural source is an alkaline deposit that hosts at least one of alkaline groundwater, alkaline brine, carbonate, or evaporite deposit.

8. The method of claim 1, wherein the natural source is alkaline water, the extracting the alkaline fluid from the natural source includes a surface collection method.

9. The method of claim 1, further comprising:
determining the target deployment location based on at least one of an efficiency or effectiveness of CO₂ sequestration of at least the portion of the body of water in response to the enhancing the alkalinity.

10. The method of claim 1, further comprising:
determining the target deployment location based on at least one of collected data associated with at least one of the body of water, historical data associated with the body of water, environmental conditions, or deployment methods.

11. A method, comprising:
extracting an alkaline fluid from a natural source;
forming an aggregate substrate;
activating at least a portion of the aggregate substrate via the alkaline fluid, the activating resulting in at least one of a binding or a curing of at least the portion of the aggregate substrate;
deploying the aggregate substrate at a target deployment location in a body of water; and
enhancing an alkalinity of at least a portion of the body of water based at least in part on the aggregate substrate being deployed therein.

12. The method of claim 11, wherein the aggregate substrate is a buoy including a partially cementitious material, the activating at least the portion of the aggregate substrate includes binding the partially cementitious material with a binder formed at least in part by the alkaline fluid.

13. The method of claim 11, further comprising:
allowing at least a portion of the aggregate substrate to dissolve in the body of water over a predetermined time,
the enhancing the alkalinity of at least the portion of the body of water is based at least in part on the aggregate substrate dissolving over the predetermined time.

14. The method of claim 13, further comprising:
seeding the aggregate substrate with a target product prior to the deploying, the predetermined time being a predetermined time of the target product growing and accumulating biomass.

15. The method of claim 14, further comprising:
allowing, after the predetermined time, at least a portion of the aggregate substrate and the target product to sink to a bottom of the body of water.

16. The method of claim 14, wherein the enhancing the alkalinity of at least the portion of the body of water neutralizes acidification associated with the target product growing and accumulating biomass.

17. An alkalinity enhancement system, the system including:
an extractor configured to extract an alkaline fluid from a natural source; and
a conveyor configured to convey at least one of the alkaline fluid or an aggregate substrate formed at least in part by the alkaline fluid to a target deployment location in a body of water, the at least one of the alkaline fluid or the aggregate substrate conveyed to the target deployment location operable to enhance an alkalinity of at least a portion of the body of water.

18. The system of claim 17, wherein the conveyor includes a buoy.

19. The system of claim 18, wherein the buoy is configured to gradually degrade in the body of water, thereby releasing alkalinity associated with the alkaline fluid.

20. The system of claim 18, wherein the buoy is formed of a partially cementitious material, a binder of the cementitious material being formed at least in part by the alkaline fluid.

21. The system of claim 17, wherein the extractor is configured to extract alkaline fluid via at least one of well-drilling, recirculation, or surface collection.

22. The system of claim 17, wherein enhancing the alkalinity of at least the portion of the body of water removes CO₂.

23. The system of claim 22, wherein the amount of CO₂ removed is quantified based at least in part on measuring an amount of tracer-ions.

24. The system of claim 23, wherein the amount of CO₂ removed is quantified without knowing a volume of at least the portion of the body of water having the enhanced alkalinity.

25. The system of claim 17, wherein enhancing the alkalinity of at least the portion of the body of water neutralizes acidification of at least the portion of the body of water.

26. The system of claim 17, wherein enhancing the alkalinity of at least the portion of the body of water neutralizes acidification of the at least the portion of the body of water.

27. The system of claim 26, wherein enhancing the alkalinity of at least the portion of the body of water neutralizes acidification associated with ancillary processes associated with CO₂ removal.
